(19) United States
(12) Patent Application Publication
(10) Pub. No.: US 2005/0234771 A1
(43) Pub. Date: Oct. 20, 2005

(54) Method and system for providing intelligent in-store couponing

(76) Inventors: Linwood Register, Marietta, GA (US); Robert H. Powell, Idaho Falls, ID (US); Michael D. Landon, Idaho Falls, ID (US)

Correspondence Address: KIRTON & McCONKIE;Suite 1800, 60 East South Temple, Salt Lake City, UT, 84111, US

(21) Appl. No.: 11/047,447

(22) Filed: Jan. 31, 2005

Related U.S. Application Data
(60) Provisional application No. 60/541,542, filed on Feb. 3, 2004.

(51) Int. Cl. G06F 17/60

(52) U.S. Cl. 705/14

(57) ABSTRACT

The present invention features an intelligent in-store couponing system comprising an operating computer for controlling the functions of the intelligent in-store couponing system; a coupon database capable of storing coupons and coupon data or information; a coupon management module for managing the coupons and their delivery; and at least one coupon delivery system capable of delivering a coupon to a customer in a usable format at the point-of-sale and/or point-of-decision. The in-store couponing system is preferably computer network-based and controlled by personnel at an individual business location or business chain, or by an administrative body controlling one or more of the functions of a business location or chain. The in-store couponing system may further be interfaced or integrated with an in-store media broadcasting and/or customer entrance detection and tracking system to provide ad-driven in-store couponing.

### RELATED APPLICATIONS

This application claims priority to U.S. provisional application Ser. No. 60/541,542, filed Mar. 25, 2004.

### BACKGROUND

1. Field of the Invention

The present invention relates to systems and methods for marketing products and services such as advertising and selling of such products and services, and particularly to a method and system for providing intelligent in-store couponing, such that customers of a business location may be provided coupons at the point-of-decision or the point-of-sale.

2. Background of the Invention and Related Art

Coupons and the idea of couponing have long been used by retail and other businesses to attract customers to their stores and to entice customers into purchasing particular products and services. There are many conventional types of couponing methods, the most popular perhaps being the publishing of coupons by merchants or advertisers and providing these coupons through various media, such as newspapers and magazines. Coupons are also often received in bulk, such as through the mail, wherein several merchants or businesses provide coupons through a common sender. Typically, coupons offer a discount on a product or service, or offer an additional discount on the same or similar item provided that a designated item is purchased first.

Advertisers and merchants continuously seek new methods for attracting as many people as possible and for promoting goods and services to as many of the population as possible. Although traditional couponing provides some success, there are several inherent deficiencies in the methods used, as well as in the coupons themselves. For several reasons, many individuals look upon couponing as a burden that does not offset the financial advantages that may be enjoyed if coupons were frequently used. First, to utilize a coupon, one must clip the coupon from the medium or collect a coupon from the packet containing the coupon, keep track of the coupon, and then physically take the coupon to the business location to redeem the coupon. This is problematic because it is time consuming to sift through newspapers, magazines, etc. to locate those coupons that may be of interest to the individual. This is perhaps the major reason that many people do not practice couponing, although many, if not all, would appreciate the money saving benefits of the coupon. Moreover, it is very easy to lose these coupons once they are clipped or collected, and, without actually presenting the coupon, most businesses will not honor the offer stated on the coupon. Second, one is inundated with several coupons of no interest to the individual. It is very frustrating to sift through numerous coupons that one is not interested in just to find those that are of interest. This is also a major factor in the choice not to practice couponing. Third, advertisers and merchants are forced to provide coupons that they anticipate or calculate, using various statistical models, will reach the most people and be of interest to the majority of shoppers. As such, coupons tend to be general in nature, thus leading to an increase in the number of coupons published because advertisers and merchants must reach as many people as possible and sell as many products and services as possible. Fourth, traditional coupons usually comprise an expiration date, wherein the coupon must be used prior to this time. Although this may seem to be a sufficient time in the future, many coupons get placed in wallets or purses and are forgotten until sometime after the validity period, thus making the coupon worthless. It should be noted that the above description is based on knowledge of the present inventors and not necessarily that known in the art.

Accordingly, there is a need for a more efficient, intelligent couponing system that is capable of increasing the effectiveness of coupons and the likelihood people will use coupons and participate in couponing practices.

### SUMMARY OF THE INVENTION

The present invention comprises an intelligent in-store couponing system that allows businesses to provide in-store coupons to its customers, thus increasing the influence over customer purchasing habits at both the point-of-decision and the point-of-sale. The preferred exemplary embodiments of the present invention improve upon existing systems and methods, and can, in some instances, be used to overcome one or more problems associated with or related to such existing systems and methods.

In accordance with the invention as embodied and broadly described herein, the present invention features an intelligent in-store couponing system comprising an operating computer for controlling the functions of the intelligent in-store couponing system; a coupon database capable of storing coupons and coupon data or information; a coupon management module for managing the coupons and their delivery; and at least one coupon delivery system capable of delivering a coupon to a customer.

In another exemplary embodiment, the intelligent in-store couponing system further comprises an in-store media broadcasting system, wherein the couponing functions are integrated with an in-store broadcast to provide ad-driven couponing. In this embodiment, various coupons are associated with one or more broadcast segments, whether said association is by manual user association, or automatic association, such as through a dynamic schedule that schedules the broadcast content to be played and the coupons that are to be triggered upon the playing of certain broadcast segments. Coupons are most likely triggered upon the playing or broadcast of product sponsored advertisements or announcements.

In still another exemplary embodiment, the intelligent in-store couponing system further comprises a customer entrance detection and tracking system that works in conjunction with or itself comprises a customer information storage and management system. Based on stored customer data that is previously obtained, coupons may be generated that target specific customers or groups of customers. Moreover, the customer entrance detection and tracking system may also be integrated with the in-store media broadcasting system, wherein the detection of certain customers will trigger certain broadcast content. Coupons associated with either the broadcast or the customer may be generated and provided to the detected customer.

The operating arrangements for the various embodiments of the intelligent in-store couponing system are numerous. Preferably, some type of computer network is utilized to link and connect each of the various components. However, in simplified operating arrangements a computer network may be dispensed with, such as in the case of a stand-alone system in operation within a single business location, wherein the coupon delivery system is directly connected to the operating computer.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a general diagram of an intelligent marketing system comprising several constituent systems linked together by a computer network;

FIG. 2 illustrates a representative system that provides a suitable operating environment for use of the present invention;

FIG. 3 illustrates a general network-based system in which the technology of the present invention may be implemented;

FIG. 4 illustrates a network diagram of an exemplary operating arrangement of a basic intelligent in-store couponing system;

FIG. 5 illustrates a network diagram of an exemplary operating arrangement of a centrally controlled intelligent couponing system;

FIG. 6 illustrates a network diagram of an exemplary intelligent in-store couponing system as integrated with an in-store media broadcasting system and a customer detection and tracking system;

FIG. 7 illustrates an exemplary paper couponing system;

FIG. 8 illustrates an exemplary paperless or paper couponing system;

FIG. 9 illustrates the operating computer of the intelligent in-store couponing system and its ability to access various system databases;

FIG. 10 illustrates a flow diagram of a method for providing general intelligent couponing;

FIG. 11 illustrates a flow diagram of a method for providing intelligent couponing by integrating into the couponing system an in-store media broadcasting system;

FIG. 12 illustrates a flow diagram of a method for providing intelligent couponing by integrating into the couponing system a customer entrance detection and tracking system;

FIG. 13 illustrates a general flow diagram of an exemplary in-store couponing method using the intelligent in-store couponing system of the present invention; and

FIG. 14 illustrates a flow diagram of an embodiment of a couponing system incorporating the ability to determine if a requested coupon exists.

### DETAILED DESCRIPTION OF THE PREFERRED EMBODIMENTS

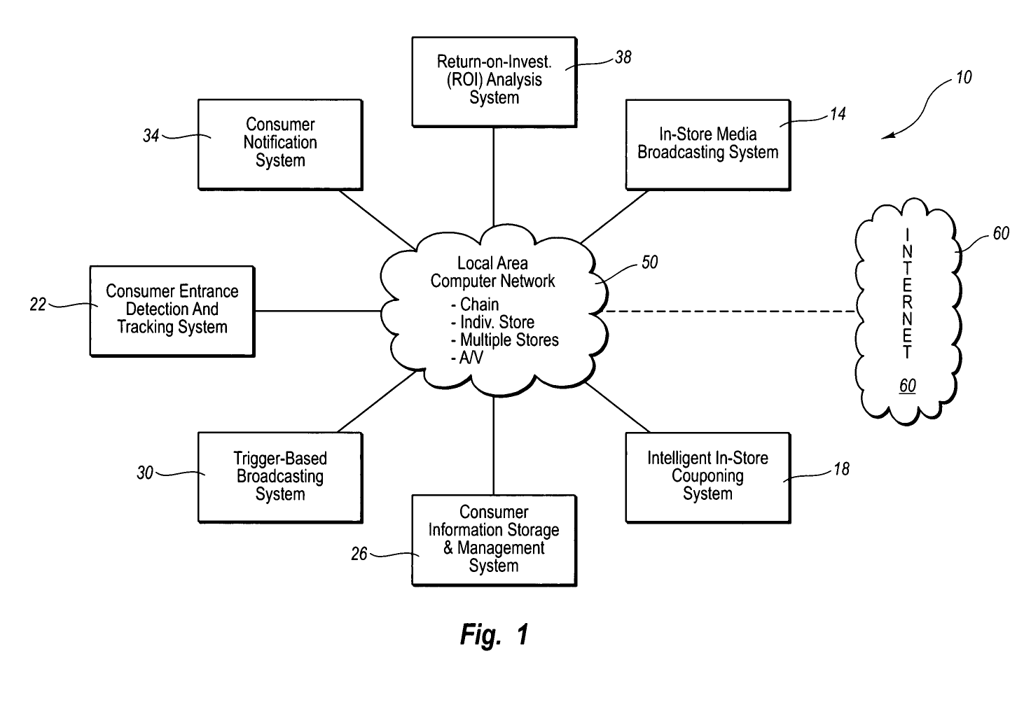

It will be readily understood that the components of the present invention, as generally described and illustrated in the figures herein, could be arranged and designed in a wide variety of different configurations. Thus, the following more detailed description of the embodiments of the system and method of the present invention, and represented in FIGS. 1 through 13, is not intended to limit the scope of the invention, as claimed, but is merely representative of the presently preferred embodiments of the invention.

The presently preferred embodiments of the invention will be best understood by reference to the drawings wherein like parts are designated by like numerals throughout.

The present invention features and describes a system for intelligent in-store couponing, preferably utilizing the advantages of an in-store media broadcasting system in one or more ways. The present invention further features and describes various methods of doing business or methods for providing intelligent in-store couponing. The intelligent in-store couponing systems and methods of the present invention may be practiced according to several various embodiments or configurations, many of which are presented below as exemplary, preferred, or other alternative embodiments.

For convenience, the specific features and characteristics of the present invention systems and methods will be set forth and described below in thee primary sections. The first section and area of discussion pertains to and sets forth in a general manner an exemplary intelligent in-store marketing system comprising various constituent component systems. The second section and area of discussion pertains to and sets forth specifics of various exemplary systems for providing intelligent in-store couponing, including their physical characteristics, features, functions, abilities, and advantages. The third section and area of discussion pertains to and sets forth several exemplary methods of providing intelligent in-store couponing using a system, such as the one described herein. These sections are not to be construed to impose limitations on the present invention in any way, nor should their contents be construed as limiting in any way.

### Intelligent In-Store Marketing System

The present invention comprises one aspect or component of a method and system for providing an entire intelligent in-store network that utilizes one or more or all of various computer, media and other audio/visual broadcasting, coupon generation, data compiling and storage, and other systems to introduce or provide intelligent advertising, selling and promotion of goods and services, information delivery, coupon generation, customer tracking, and other similar or peripheral functions and business methods preferably to a retail or other store or business location, or on any other in-store or similar basis. The phrase intelligent in-store marketing system is a general phrase intended to define and encompass each of these in a total system, as well as to include the various possible configurations and intelligent functions the total system is capable of performing, although many, if not all, constituent systems are capable of functioning independently without the others, if so desired.

As stated, the intelligent in-store marketing system 10 is preferably made up of several constituent components and/or systems, each contributing their respective functions to enable the total system and associated methods to function as intended, namely to enable the intelligent in-store marketing system to perform various smart functions and/or to convert traditional business-related functions, such as advertising, selling, coupon generation and delivery, identifying and utilizing customer shopping habits, and other such functions into smart functions, each of which were not otherwise possible with current related art. As such, each component system plays a significant role, some of which may or may not be dependent upon other components or systems.

In one exemplary embodiment, and with reference to FIG. 1, the intelligent in-store marketing network 10 of the present invention comprises several individual and operably interconnected components or systems, which components or systems interact and function together or separately to introduce intelligence into many traditional business operations or functions. Not to be considered or construed as limiting, in this particular embodiment intelligent in-store marketing system 10 comprises, as its constituent components, an in-store media broadcasting system 14, which is preferably a computer network-based media broadcasting system, wherein various music, video, announcements, advertisements, and other information is broadcast throughout a store or business location; an intelligent in-store couponing system 18 that functions to generate and deliver coupons to customers at the point-of-decision (POD) or point-of-sale (POS); a consumer or customer entrance and/or presence detection and tracking system 22, which functions to notify store owners, managers, or employees that a particular customer has entered the store and allows them to track the purchases and other in-store habits of any participating customer; a customer data collection or gathering, compilation, storage and management system 26 (hereinafter customer storage and management system 26) that interfaces with customer entrance detection and tracking system 22 to gather and collect specific customer data and to store this data in a efficiently manageable and retrievable format; a trigger-based media broadcasting system 30; a customer notification and interaction system 34 for interacting with the customer on an as needed basis or for delivering requested information or customer items, such as electronic coupons; and a return-on-investment analysis and reporting system 38 that allows store owners, managers, system administrators, network personnel, and others to obtain, review, analyze, and receive reports on the effectiveness of the various intelligent in-store systems with respect to encouraged and participated in customer activity.

In a complete or total system each of these systems are preferably interconnected and in communication with one another via an in-store computer and/or audio/visual network 50 (hereinafter in-store network 50). Of course, if any system is independently operated, it alone may be connected with in-store network 50. In addition, intelligent in-store marketing system 10 may further be operably connected and in communication with a global user or wide-area network 60, such as the Internet. Each system may be independently and directly connected to global user network 60 or indirectly connected via in-store network 50.

The phrase “business location” is intended to mean any commercial retail or outlet store (e.g., shopping mall, grocery store, convenience store, etc.), any type of commercial service oriented business (e.g., a dental or doctor's office, etc.), or any other type of location that is visited by the public, whether it be a location in which a business is being operated for profit, or one housing a non-profit organization. In essence, the present invention is intended to be adaptable to any location in which it would be desirable to utilize the technology of the present invention as discussed and described herein and illustrated in the accompanying Figures.

The phrase “business chain” is intended to mean a plurality of business locations that are either owned or managed in a some type of common manner, whether affiliated with one another in some way or not.

The term “in-store” is intended to mean within or about the physical premises of a business location or a business chain. “In-store” is also used to describe and define the operating domain of the present invention intelligent couponing system and method, which domain includes, but is not limited to, the actual physical premises of a business location or business chain, any online or computer network supported address (e.g., an Internet web-site), any remote contacting means used for contacting customers without the store for the purpose of attracting their business (e.g., messaging a customer on a cell phone when out of the store providing a coupon that is redeemable if they come into a sponsoring or participating business location or visit the sponsoring business location's website), any combination of these, and/or any others not presented herein, but recognized by those skilled in the art.

The term “couponing” or “coupon” is intended to mean any type of means used to discount goods or services of a business location or business chain, such as providing paper coupons, paperless or electronic coupons, notifications of discounted items or services, buy one get one free offers, etc. to customers. “Couponing” may also mean any type of means for promoting and offering goods or services, either for a discounted price or for other purposes.

For purposes of the present invention, the particulars of intelligent in-store couponing system 18 are discussed in detail below, including how this system interacts or is operable with some of the other systems in intelligent in-store marketing system 10.

### Intelligent In-Store Couponing System

The present invention intelligent in-store couponing system comprises many operating arrangements. The couponing system may be a stand alone system, or it may be interfaced or integrated with other systems, such as an in-store network, an in-store media broadcasting system, a customer entrance detection and tracking system, and others. Or, the intelligent in-store couponing system may itself comprise various systems, such as an in-store media broadcasting or customer entrance detection system. In each of its operating arrangements, the intelligent in-store couponing system comprises various hardware and software components that interact with each other to carry out the intended function of the present invention. While the system, its software, the associated network and communications, the several operating arrangements, and the corresponding methods of doing business are all specifically described, such descriptions are provided with the intention of encompassing like-systems, like-devices, and/or like-methods, aside from those not specifically described or mentioned herein, but that would nonetheless be obvious to one ordinarily skilled in the art. As such, these are not meant to be limiting in any way.

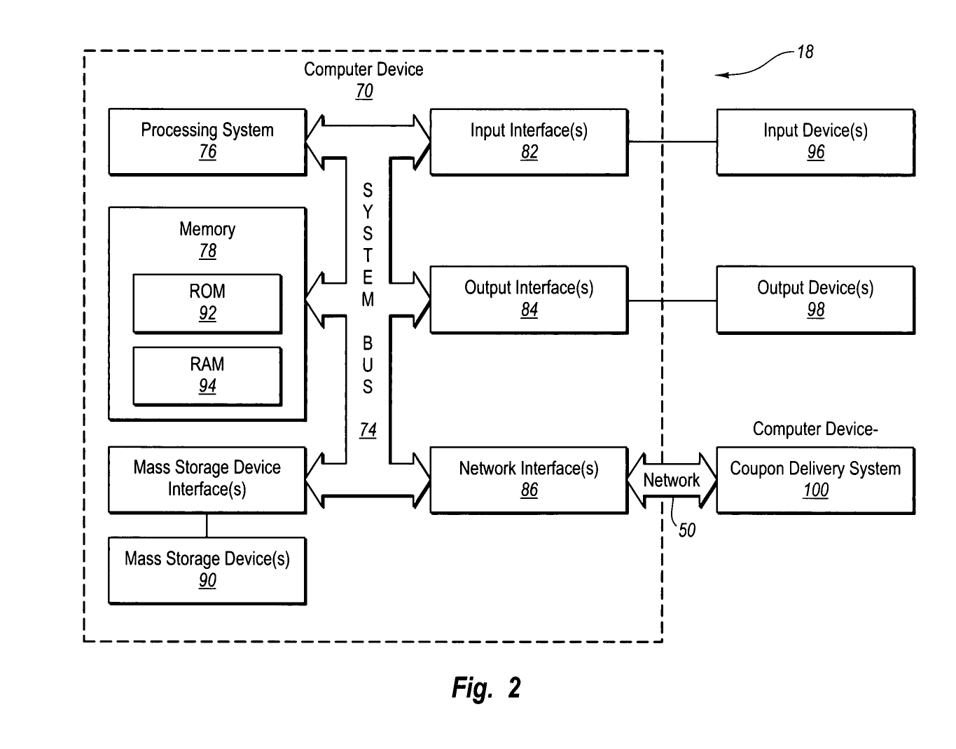

FIG. 2, along with its corresponding discussion, is intended to provide a general description of a suitable operating environment in which some embodiments of the invention may be implemented. One skilled in the art will appreciate that the invention may be practiced by one or more computing devices and in a variety of system configurations, particularly within in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 2, a representative system for implementing the invention includes operating computer 70, which may be a general-purpose or special-purpose computer. For example, operating computer 70 may be a personal computer, a notebook computer, a personal digital assistant (“PDA”) or other hand-held device, a workstation, a minicomputer, a mainframe, a supercomputer, a multi-processor system, a network computer, a processor-based customer electronic device, or the like.

Operating computer 70 includes system bus 74, which may be configured to connect various components thereof and enables data to be exchanged between two or more components. System bus 74 may include one of a variety of bus structures including a memory bus or memory controller, a peripheral bus, or a local bus that uses any of a variety of bus architectures. Typical components connected by system bus 74 include processing system 76 and memory 78. Other components may include one or more mass storage device interfaces 80, input interfaces 82, output interfaces 84, and/or network interfaces 86, each of which will be discussed below.

Processing system 76 includes one or more processors, such as a central processor and optionally one or more other processors designed to perform a particular function or task. It is typically processing system 76 that executes the instructions provided on computer readable media, such as on memory 78, a magnetic hard disk, a removable magnetic disk, a magnetic cassette, an optical disk, or from a communication connection, which may also be viewed as a computer readable medium.

Memory 78 includes one or more computer readable media that may be configured to include or includes thereon data or instructions for manipulating data, and may be accessed by processing system 76 through system bus 74. Memory 78 may include, for example, ROM 92, used to permanently store information, and/or RAM 94, used to temporarily store information. ROM 92 may include a basic input/output system (“BIOS”) having one or more routines that are used to establish communication, such as during start-up of operating computer 70. RAM 94 may include one or more program modules, such as one or more operating systems, application programs, and/or program data.

One or more mass storage device interfaces 80 may be used to connect one or more mass storage devices 90 to system bus 74. The mass storage devices 90 may be incorporated into or may be peripheral to operating computer 70 and allow operating computer 70 to retain large amounts of data. Optionally, one or more of the mass storage devices 90 may be removable from operating computer 70. Examples of mass storage devices include hard disk drives, magnetic disk drives, tape drives and optical disk drives. A mass storage device 90 may read from and/or write to a magnetic hard disk, a removable magnetic disk, a magnetic cassette, an optical disk, or another computer readable medium. Mass storage devices 90 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 82 may be employed to enable a user to enter data and/or instructions to operating computer 70 through one or more corresponding input devices 96. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 82 that may be used to connect the input devices 96 to the system bus 74 include a serial port, a parallel port, a game port, a universal serial bus (“USB”), a firewire (IEEE 1394), or another interface.

One or more output interfaces 84 may be employed to connect one or more corresponding output devices 98 to system bus 74. Examples of output devices 98 include a monitor or display screen, a stereo system, one or more speakers, a printer, and the like. A particular output device 98 may be integrated with or peripheral to operating computer 70. Examples of output interfaces include a video adapter, an audio adapter, a parallel port, and the like.

One or more network interfaces 86 enable operating computer 70 to exchange information with one or more other local or remote computer devices, such as a coupon delivery device or system, illustrated as computer devices 100, via a network 50 that may include hardwired and/or wireless links. Examples of network interfaces include a network adapter for connection to a local area network (“LAN”) or a modem, wireless link, or other adapter for connection to a wide area network (“WAN”), such as the World Wide Web or the Internet. The network interface 86 may be incorporated with or peripheral to operating computer 70. In a networked system, accessible program modules or portions thereof may be stored in a remote memory storage device. Furthermore, in a networked system operating computer 70 may participate in a distributed computing environment, where functions or tasks are performed by a plurality of networked computer devices.

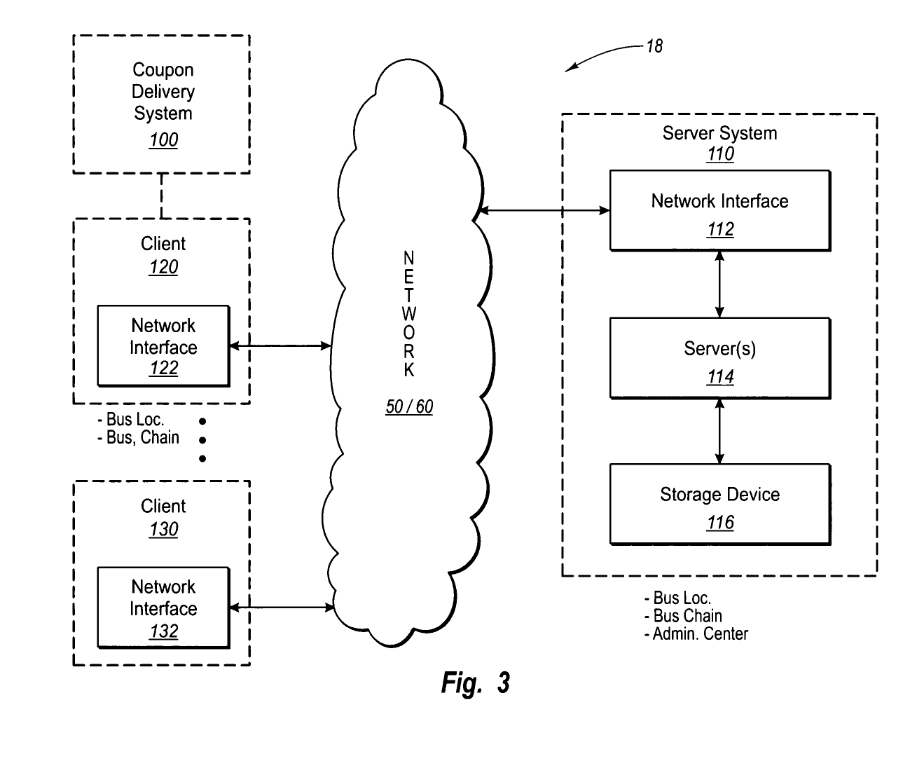

While those skilled in the art will appreciate that the invention may be practiced in networked computing environments with many types of computer system configurations, FIG. 3 represents an embodiment of the present invention in a networked environment that includes clients connected to a server via a network, wherein the clients may be a business location or business chain computer with the possibility of further connecting to a coupon delivery device or system. While FIG. 3 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet.

Generally, FIG. 3 represents an exemplary arrangement of the present invention intelligent in-store couponing system. Specifically, in FIG. 3, server system 110 represents a system configuration that includes one or more servers that are used to provide and execute the couponing functions as described and claimed herein. By way of example, server system 110 may be a single server in cases where a single server can process and preserve the entire amount of information required to perform the methods of the present invention that are disclosed herein. Alternatively, server system 110 may be a conglomeration of servers that process and preserve a high volume of information. In one exemplary embodiment, server system 110 may be located and operated at a business location to control the couponing at that business location only. In this embodiment, client 120 may comprise various local computers, as well as one or more coupon delivery systems. In an alternative exemplary embodiment, server system 110 may be located and operated at a business chain to control the couponing of several business locations. In this embodiment, clients 120 and 130 may comprise various computers at each representative business location, as well as one or more coupon delivery systems, such as those located at the various business locations. In another alternative exemplary embodiment, server system 110 may be located operated at an administration center that controls the couponing and other functions of several business chains. In this embodiment, clients 120 ands 130 may comprise representative business chain computers or computer systems, business location computers, or one or more coupon delivery systems, such as those located at various business locations.

The embodiment illustrated in FIG. 3 comprises a plurality of clients, illustrated as clients 120 and 130, connected to server system 110 across network 50/60 in order to provide the intelligent couponing services and functions described herein. Network 50/60 may include a wireless network, a local area network, and/or a wide area network.

With reference to FIG. 3, clients 120 and 130 include a network interface (respectively illustrated as network interfaces 122 and 132), such as a web browser or other network interface. Network interface 122 is a communication mechanism that allows client 120 to communicate with server system 110 via a network 50/60, such as the Internet.

Server system 110 includes network interface 112, application servers 114, and storage device 116. Network interface 112 is a communication mechanism that allows server system 110 to communicate with one or more clients via network 50/60. Application servers 114 include one or more servers for processing and/or preserving information, and may be employed for providing and maintaining a web page that may be accessed by a client. Storage device 116 includes one or more storage devices for preserving information, such as demographic information, professional information, customer information, billing information, or any other type necessary to the methods and systems disclosed herein. Storage device 116 may be internal or external to application servers 110. While the discussion above has presented a representative system configuration for implementing the present invention, those skilled in the art will appreciate that the methods of the present invention and processes thereof may be implemented in a variety of system configurations.

The concept of the present invention provides a unique paradigm shift from prior art couponing systems and methods, such as those described earlier. While the preferred delivery mechanism is computer network based, other delivery mechanisms or means are also contemplated, such as satellite, and others. The intelligent in-store couponing system 18, in its simplest form, features a computer network-based system, such as an Internet, Intranet, or other computer network based system, comprising one or more computer systems in communication with at least one, and preferably several or a plurality of, coupon delivery systems 100.

Incorporated into the discussion of the physical components of the intelligent in-store couponing system are the proprietary software application modules that enable the system to operate and function as intended.

The operating system used to control the intelligent in-store couponing system is preferably selected from the group consisting of a Linux® operating system, a Microsoft® operating system, an Apple or Macintosh® operating system, a System V Unix® operating system, a BSD Unix® operating system, an OSF Unix® operating system, an IBM® Mainframe MVS operating system, and/or other operating systems as will be known by one skilled in the art. In addition to the components of each computer system described and the operating systems anticipated, other components are intended to be included in each computer system as commonly known by one ordinarily skilled in the art. Moreover, each computer system is capable of storing and executing at least one application software program thereon in accordance with the teachings of the present invention.

### Couponing System

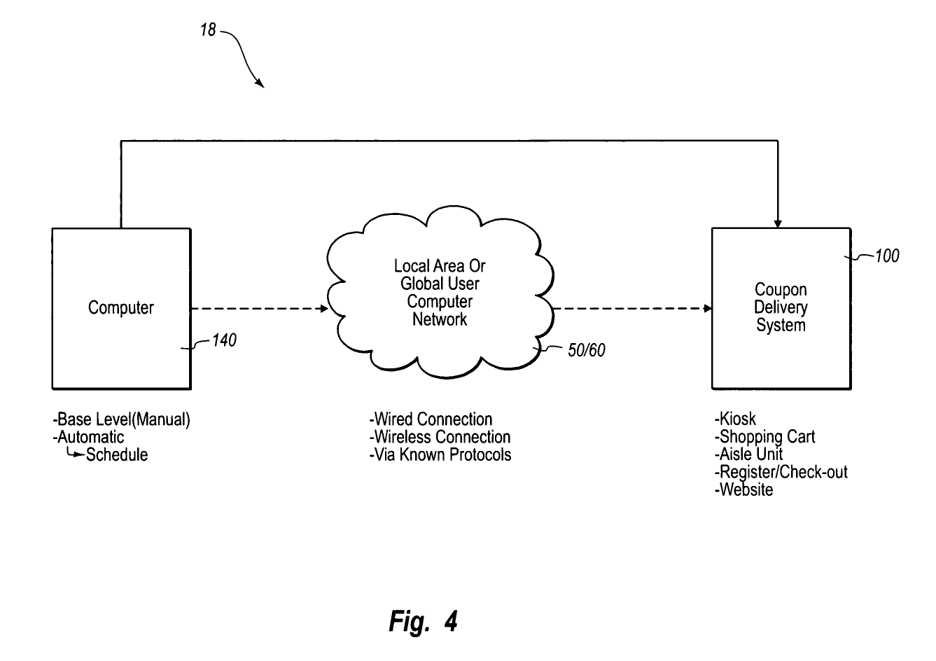

The in-store couponing system and method of the present invention comprises several configurations and embodiments. In one exemplary embodiment, with reference to FIG. 4, intelligent in-store couponing system 18 comprises a computer or computer system 140 that may be a business location computer controlling only the couponing functions for that particular business location, a business chain computer controlling the couponing functions of several business locations, or a server system at a business location or a business chain. Computer 140 is operably connected and in communication with computer network 50/60, which comprises either an in-store network 50 (e.g., a local area network, an audio/visual system, etc.) or a global computer network 60, depending upon the particular operating arrangement. The communication between components in the network may be by any known means, such as a wired or wireless connection, using various protocols commonly known in the art. Also in communication with computer 140 and/or computer network 50/60 is coupon delivery system 100, which functions to deliver a coupon to the customer, whether the coupon is in the form of a paper coupon, a paperless coupon, a notification coupon, or others. Coupon delivery system 100 preferably comprises programming that would enable it to communicate over well-defined protocols. Coupon delivery system 100 may or may not comprise local data storage, thus, no local hard drive. The operating system and coupon software could be embedded to keep costs down. However, upgrading would be difficult and expensive.

One exemplary system configuration or operating arrangement for providing a business location an intelligent couponing system in its simplest form is illustrated in FIG. 4, wherein the intelligent couponing system exists independently of other intelligent systems, or rather is a stand-alone system not interfaced with any other intelligent systems, such as those described above in FIG. 1. In such an arrangement, several different operating arrangements are made possible, some of which are discussed below. It should be noted that the operating arrangements presented in FIG. 4 provide several base-level designs. Indeed, all of the functions and features of the present invention discussed with respect to FIG. 4 may be incorporated into any of the remaining operating arrangements.

In one exemplary embodiment, FIG. 4 illustrates computer 140 that is physically located at and operated from a business location. Computer 140 comprises various processing, memory storage, and other components necessary to execute one or more couponing functions via a coupon management module stored and executable on computer 140. Computer 140 is operably connected to and in direct communication with at least one coupon delivery system 100, that is also located at the business location. The connection means used for connecting and facilitating communication between computer 140, in-store network 50, and coupon delivery system 100 may be any known in the art, such as any type of wired connection, any type of wireless connection (e.g., infrared, Bluetooth, etc.), or a combination of these.

In this arrangement, a store manager, employee, or other authorized person may operate the coupon management system stored on computer 140 to generate, manipulate, and deliver to one or more customers an in-store coupon. One way of determining the coupons to be provided is manually. For example, a store manager may determine the various coupons to be provided on a daily, weekly monthly, or yearly basis. When the time comes to generate and deliver the coupon, the manager may access the coupon management module from computer 140, generate, modify, or select a pre-existing coupon, assign the desired parameters to the coupon and execute the delivery of the coupon to coupon delivery system 100. One scenario may be when a store manager desires to move a certain item at an accelerated pace or reduce an overstocked or high volume item.

The store manager may place a kiosk or portable coupon delivery system 100 in the vicinity of the item, manually generate a new or select a pre-existing coupon corresponding to the selected item, announce over to the customers then in the store, such as over the intercom system, that in the next few hours there will be a sale on a particular item, and provide a coupon for the item at the very location of the item, otherwise known as the point-of-decision. As customers hear the announcement, they may then locate the item and coupon delivery system 100 near by, receive their coupon from the coupon delivery system 100, and purchase the item according to the terms and conditions of the coupon, such as at a reduced price. Another scenario may be that coupons may be generated and delivered based on in-store advertisements or announcements broadcast over an in-store broadcasting system. An in-store personnel may trigger a coupon based on an advertisement that is coming up, is currently playing, or that just finished playing. This will make advertising much more effective because customers not only hear the advertisement, but they are immediately offered a coupon on the advertised item or service.

Another way the coupons may be generated and delivered is automatically according to a schedule or other determinate as set up and managed within the coupon management module or other similarly capable program. The coupon management module may comprise a scheduling program that allows any authorized person to create and manage a schedule of coupons. The schedule may allow authorized personnel to keep track of and assign such parameters as the date, time, number, and frequency the coupons are to be delivered. Other parameters may also be included and entered into the schedule, such as to whom the coupons are to be delivered, and the period of validity for each coupon. This schedule may be set up to generate and deliver coupons randomly, or it may follow one or more programs as desired by the authorize store personnel, or, in a more preferred arrangement, the schedule may be more sophisticated so as to integrate or synchronize with other intelligent in-store systems, such as a customer entrance detection and tracking system, or an in-store media broadcasting system (e.g., those shown in FIG. 1).

The coupon schedule may be separate or independent from the broadcast schedule used to provide the media broadcast in the business location. In this situation, in-store personnel may still match the generation and delivery of certain coupons with particular advertisements or announcements, but the delivery of the coupons would be manually controlled and entered into the system to appropriately correspond to the broadcast schedule. Alternatively, the coupon schedule and the broadcast schedule are integrally connected or formed together into a single schedule where the coupons and broadcast are automatically provided according to the schedule.

The generation and delivery of coupons may be random, scheduled, and/or upon the happening of one or more triggering advertisements or events. Preferably, the coupons are synchronized with an in-store media broadcasting system and are generated and delivered according to one or more triggering advertisements or events. The flexibility in the system allows the coupons to be generated as desired. For instance, it is contemplated that coupons may be generated and delivered to correspond to seasonal or weather changes, sporting events, promotions, holidays, and any other influencing happenings or occurrences.

For instance, coupons may be provided in response to weather or seasonal changes. If it is cold outside, in-store personnel may select to provide coupons for various products related to the cold weather, such as cold medicine, hot chocolate or coffee, blankets, winter clothing, and others; or if it begins to rain, in-store personnel may decide to provide a coupon for umbrellas or other items that would be desirable in such weather. Another example would be sports related coupons. In locations where sporting events are being held, various sports related coupons could be provided either before, during, and/or after the event. In still another example, coupons may be provided in response to different shopper demographics. For instance, if during the times between 10 a.m. and 3 p.m. the store comprises 70% women, coupons may be provided that are directed to those items or services that may be of particular interest to women. These are just a few examples in which the present invention intelligent in-store couponing system may be utilized and how it could benefit businesses. Obviously, all of the different situations or circumstances cannot be presented herein. However, these will be recognizable and obvious to one skilled in the art.

Coupon delivery system 100 comprises any type of device or system capable of delivering a coupon to a customer in a usable or redeemable format as directed by computer 140 and the coupon management module stored thereon. As stated, coupon delivery system 100 may be a type of printing device that prints out a physical paper coupon for use by the customer, or coupon delivery system 100 may comprise a device capable of transferring an electronic or paperless coupon to the customer (e.g., onto a smart card or customer loyalty card); or coupon delivery system 100 may comprise a system that notifies a customer of a coupon via a personal device of the customer (e.g., cell phone, PDA, etc.). Some of the contemplated coupon delivery systems include, but are not limited to, a kiosk located at any desired location within the business location; a shopping cart system that is supported directly on the shopping cart; a portable unit capable of being mounted or placed at various locations around the store, such as in aisles, at checkout stands, outside the store, etc.; a point-of-sale system; an internet web site; a customer's personal device (e.g., a cell phone, PDA, laptop, etc.); and others. Any one or more of these devices or systems may be in place at a particular business location.

The present invention further contemplates a plurality of coupon delivery systems at a single business location, perhaps each different in type. Providing different or a plurality of coupon delivery systems provides businesses the ability to generate and deliver different coupons to different coupon delivery devices existing within a single business location. Each coupon delivery system may be independently controlled and operated through the coupon management module on computer 140. Multiple coupon delivery systems provides an even greater amount of flexibility for businesses as they can target different parts or segments of the store, and therefore different customers, with different offers, if so desired.

In another exemplary embodiment, FIG. 4 illustrates computer 140 that is stored and operated from a business location, but operably connected to and in communication with one or more coupon delivery devices 100 through an in-store network connection 50 (e.g., Intranet). This embodiment is similar in function to the one just described, only the coupon delivery system 100 is not directly connected to computer 140, but is operated through a network connection.

In one exemplary operating arrangement, network 50 may comprise a business location Intranet that couples or connects an in-store audio/visual system, a media broadcasting system, or any other common networked system. This network may also connect intelligent in-store couponing system 18. Utilizing network 50 enables more efficient control of and communication with intelligent in-store couponing system 18, and particularly each of the various coupon delivery systems 100 that are located within a business location. In addition, network 50 provides a suitable interface for integrating intelligent in-store couponing system 18 with one or more other networked systems, such as an in-store media broadcasting system to create an ad-driven coupon delivery system and method. In this operating arrangement, the intelligent couponing may be synchronized with the media broadcast, such that coupons are generated and delivered in response to triggering broadcast segments, the most common being advertisements. Indeed, advertisements may be played or broadcast as directed (i.e., by schedule, manual activation, etc.) via the in-store media broadcasting system. Prior to, during, or after the playing or broadcasting of a particular advertisement, the intelligent in-store couponing system is triggered, thus delivering a corresponding coupon as pre-determined by operators of both systems. This ad-driven coupon delivery system and method is unique to the present invention and provides several advantages over prior related couponing or coupon delivery systems and methods. The ad-driven coupon delivery system and associated methods are discussed in greater detail below.

Network 50 provides a suitable interface for integrating intelligent in-store couponing system 18 with other networked systems, such as a consumer or customer entrance detection and tracking system coupled with a customer information storage and management system. In this operating arrangement, customers of various business locations are identified and their shopping habits monitored. Information about the customer (e.g., demographics, shopping habits, and other information) is solicited, gathered, compiled, and stored in a customer database for later retrieval and use by system operators and/or store personnel. This information may be utilized to trigger, or otherwise deliver, coupons from intelligent in-store couponing system 18 based any information that can be learned from the acquisition of customer information. For instance, if a store manager knows from gathered customer information that between the times of 10:00 a.m. and 3:00 p.m. that the store comprises 75% women, coupons for items or services that may be of interest to women can easily be provided. This operating arrangement is discussed in greater detail below.

FIG. 4 illustrates another exemplary embodiment in that computer 140 is a business chain computer that operably connects and is in communication with one or more coupon delivery systems 100, each located at respective business locations throughout the business chain. In this embodiment, operating computer 70 controls the intelligent in-store couponing of several business locations through a local area or in-store network 50. As such, network 50 may also comprise a business chain Intranet network linking together a plurality of individual business locations existing within the business chain, as well as any systems operating within the business chain, such as an in-store media broadcast or customer entrance detection and tracking system, as well as providing a universal couponing system. In this particular operating arrangement, network managers may efficiently and effectively control each of the coupon delivery systems 100 located in each respective business location, as well as any other systems in operation. For instance, a business chain may have in operation a media broadcasting system that is centrally controlled and operated for the benefit of each business location. The intelligent in-store couponing system may be interfaced or integrated with the media broadcasting system to provide ad-driven couponing to the plurality of business locations.

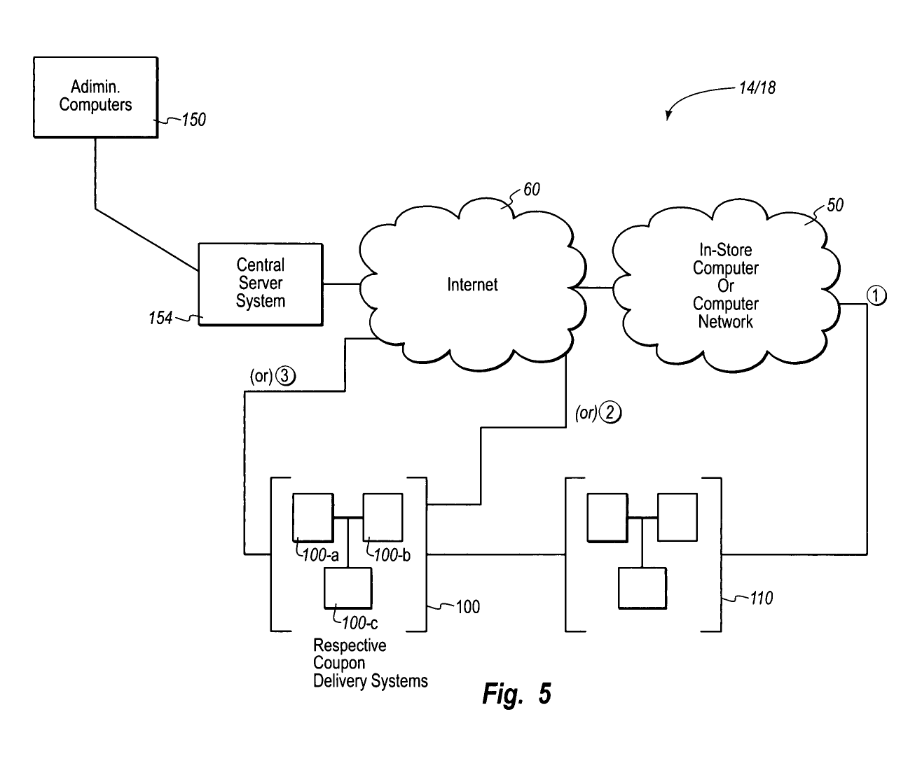

Turning now to FIG. 5, in another exemplary embodiment and on another level, the intelligent in-store couponing system 18 may be operable within an administrative arrangement, wherein one or more administration personnel, through computers 150, control the system operations of several business chains or business locations through a wide area or global user network 60, such as the Internet. As shown in FIG. 5, connections to various business chain computers 110 may be direct or through an in-store network 50, such as the one discussed above. In the operating arrangement shown in FIG. 5, administration computers are connected to a central server system 154 that comprises various servers for processing and storing data, as well as for facilitating communication with one or more business locations or one or more business chains. In one arrangement, central server system 154 is connected through network 60 to in-store computer network 50, which may be connected directly to one or more coupon delivery systems 100 or indirectly to one or more coupon delivery systems 100 through one or more client computers (business location computers).

As noted above, each business location may comprise any number of coupon delivery systems 100 and these may be controlled by administrative personnel through administration computers 150 in any connection or operating arrangement possible. Alternatively, as shown, and depending upon the type of coupon delivery system in operation, central server system 154 may be connected directly to coupon delivery systems 100 operable within one or more business chains directly through network 60. Thus, if a kiosk comprising a print coupon dispensing device is located within a business location, the coupon dispensing device may be connected to and controlled by the administration through network 60, without requiring an interface with any systems in the business location. This may be advantageous in situations where the business location has no in-store network in place. Intelligent couponing may still be possible through the network of the administration.

As stated, coupon delivery systems 100 are controlled through an administration body, wherein administration computers 150 connect to a central server 154, which in turn connect to one or more business chains or business locations via a wide area or global user network (e.g., the Internet) 60 and/or a local area or in-store network 50. Through this connection, operators of the administration body can control the couponing functions of one or more business chains and a plurality of related or non-related business locations. As shown in FIG. 5, the administration body, through its computers 150, can be given permission and access to control the computer devices 110 existing at each business location within the business chain, as well as the ability to control each coupon delivery device 100 existing throughout the business chain. In the alternative, the administration body may control each coupon delivery device directly from the local area or in-store network 50 of the business chain.

Another advantage of utilizing an administrative network arrangement is that other systems may be integrated with intelligent in-store couponing system 18 to enhance its functions and abilities. In one exemplary operating arrangement, intelligent in-store couponing system 18 may be integrally connected with an in-store media broadcast system 14, also controlled and operated by administrative personnel.

Another exemplary operating arrangement intelligent in-store couponing system 18 maybe integrally connected with a customer detection and tracking system and customer information storage and management system to trigger coupons based such things as the customer's presence within the business location or the shopping behavior of certain customers.

Although it may be advantageous to integrate several of the systems identified in FIG. 1 together, it is not necessary. Each system may be left to operate independently of any another, with coupons still being capable of being generated and delivered to customers according or in response to various advertisements, announcements, customer presence, etc. through use of some other program not requiring the systems to be integrated, such as a synchronization or scheduling program providing for pre-determined or planned (e.g., time, place, manner) coupon delivery, through manual initiation or triggering, or through other known means.

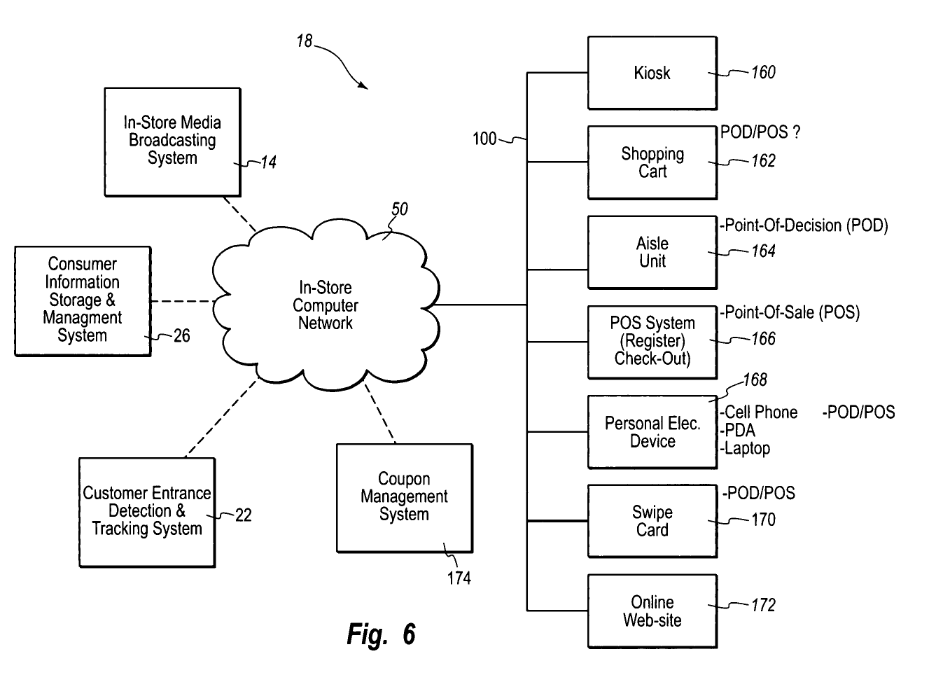

FIG. 6 illustrates the exemplary operating arrangement of a preferred intelligent in-store couponing system 18. As shown, intelligent in-store couponing system 18 comprises at least one, if not all, of an in-store media broadcasting system 14, a customer entrance detection and tracking system 22, a customer information storage and management system 26, and a coupon management module 174, each connected to and in communication with a computer network, which may be a wide area network 60 or a local area network 50 or both. Intelligent in-store couponing system 18 further comprises one or more coupon delivery systems 100 also connected to and in communication with network 50.

Coupon delivery system 100 may comprise a kiosk 160 capable of delivering a paper or paperless coupon, shopping cart device 162 that is mobile and coupled to a shopping cart and that is also capable of delivering a paper or paperless coupon, an aisle unit 164 that is similar in function to kiosk 160, but more portable and that may be placed or located anywhere about a business location, a modified point-of-sale system 166 capable of delivering paper or paperless coupons, a personal electronic device 168, such as a cell phone, Personal Digital Assistant (PDA) that is capable of delivering a paperless coupon, a swipe card system 170 capable of transferring an electronic or paperless coupon to a swipe card where the coupon may be redeemable at the point-of-sale or at another time, and an online web site that a customer may log onto to receive a paper or paperless coupon.

### Computer Network-Based In-Store Media Broadcasting System

Referring back to FIG. 1, the present invention intelligent in-store couponing system 18, and associated methods, may employ or utilize an in-store media broadcasting system 14 comprising a proprietary media distribution framework or platform supported by and/or operated by several software modules. This in-store media broadcasting system 14, and its associated business methods, are described in detail in U.S. patent application Ser. No. 10/145,920, filed May 15, 2002, and entitled, “System For and Method of Doing Business to Provide Network-Based In-Store Media Broadcasting,” and Ser. No. 10/146,192, filed May 15, 2002, and entitled, “Providing a Multi-Tier Enterprise Level Application,” each of which are incorporated by reference herein in their entirety.

In sum, the in-store media broadcasting system 14 is preferably a computer network-based broadcasting system, such as a global computer network (e.g. the Internet) system that interconnects one or more, and preferably, a plurality of client player devices placed at a plurality of business locations, each of the client player devices being independently supported and in communication with an internal audio/visual system installed and existing within in a respective business location. The media broadcast is a highly customizable media broadcast that is supported on each of the client player devices. The media broadcast may comprise various media and informational content thereon (e.g., music, video, advertisements, announcements, community information, store information, promotional information, etc.) that may or may not be specific to the particular business location in which the client player device(s) is/are located. Each one of the client player devices is in communication with one or more central servers located within a central server system operated by administrative personnel. Each client player device exchanges information and broadcast content with the central server(s) on a scheduled basis.

The central server component includes application and database servers, as well as file storage devices to store and disseminate the media content. The central server is the intelligence center of the in-store media broadcasting system of the present invention and preferably communicates with all other components connected within the framework or platform using JDBC, FTP, RML, and HTTP protocols.

The client player devices or components are essentially computers located at each business location and include software application modules that function to play and log the media broadcast. The client player device(s) also functions to connect to the central server for updates, and to receive upgrades of the software and broadcast content, including music play lists and advertisements, if available. The client player device(s) preferably communicates with the central server using JDBC, and FTP protocols, and with using XML-RPC.

In-store media broadcasting system 14 further comprises one or more system network managers that function to automate and manage the in-store media broadcasting system. This component is an independent computing device that may or may not be located on the central server. Indeed, it may be separate from the central server. The network manager component is in communication with the central server through the network configuration and is operated by IBN personnel. The system network manager component comprises a suite of software modules used to automate business functions, such as creating and modifying contracts, advertisements, and schedules. This component also provides reports to track the status of these specific functions. The network manager preferably communicates with the central server using RMI, HTTP, and JDBC protocols.

In-store media broadcasting system 14 further comprises one or more chain managers operated by business location personnel, and includes software modules designed to manage each client player device in each store in the chain and the media content contained thereon. This component is preferably a computing device separate from the client player devices, but may reside on one or more client player devices. The chain manager component communicates with the each client player device using the XML-RPC protocol, and with the central server using the RMI protocol. As stated, in-store media broadcasting system 14 comprises several proprietary software application modules functioning on one of the above-identified components to allow in-store media broadcasting system 14 to operate as intended.

The media broadcast preferably comprises music, video, advertisements, announcements, or other broadcast content organized into play lists according to various criteria (e.g. genre, date, run-time, run frequency, etc.).

Through in-store media broadcasting system 14, a national radio-advertising platform or network focusing on major retailers and service providers throughout the country is made possible. In-store media broadcasting system gives retailers and service providers the ability to broadcast customized music and messaging to their customers in any store in any part of the country. In addition, the radio-advertising network provides a targeted advertising venue for customer marketing companies and, unlike any other media, allows them to advertise products to select and targeted customers at the point of sale or at the point-of-decision, which style of advertising can be much more effective in terms of success and the number of relevant customers the advertisements actually reach.

The in-store media broadcasting system 14 may be utilized to increase the intelligence or functionality of in-store couponing system 18. By utilizing in-store media broadcasting system 14, coupons may be made to correspond to the content being broadcast. In one exemplary embodiment, intelligent in-store couponing system 18 may be interfaced with in-store media broadcasting system 14 by selectively associating certain advertisements with related coupons, thus providing ad-driven couponing. In short, ad-driven couponing means that when certain advertisements are played or broadcast through the business location, one or more corresponding coupons may be provided to customers through a coupon delivery device. Those coupons that are synchronized with the broadcast advertisements, or those ad-driven coupons, will typically comprise a discount or other incentive for the product or service being promoted or advertised.

Advertisements may also be followed up with announcements from store personnel notifying customers of available coupons for the product or service just advertised. Coupons may be generated automatically, or manually by one authorized to do so.

The media broadcasts may comprise content, such as music or video, that is appealing to customers to make them feel more relaxed and comfortable, thus increasing the likelihood that they will purchase something. The media broadcasts may further comprise certain advertisements that are triggered to play in response to certain detected customers (as discussed below), which advertisements may serve to promote certain products or services of interest to these select customers. Or, the media broadcast may comprise a combination of these. Concurrent with or in association with the broadcast are various coupons that in some way correspond or pertain to the content being broadcast and that may, in response, be provided to the customers. Through this system, advertisers and store operators and managers can provide more targeted and intelligent advertising and marketing that greatly influences customer purchasing at both the point-of-sale, and more importantly at the point-of-decision, and that increases the likelihood customers will purchase those products and services promoted. This represents powerful marketing because not only does a customer hear advertisements or other media being broadcast while in the business location, but the customer is further enticed and given immediate opportunity at the point-of-decision to respond to the stimulus by obtaining a coupon on the item or service that may be redeemed at the time of purchase. Moreover, if interfaced with a customer entrance detection and tracking and customer information system, the customer is even greater stimulated as a result of the in-store broadcast comprising content that is known to be of interest to that particular customer. As such, the effectiveness of both the advertising and the couponing of the business location is significantly increased because customers hear advertisements for products or services of high interest to them, and are provided related coupons on the spot, thus making them more likely to use the coupons and purchase the advertised product or service. As a result, advertisers will be able to create more flexible and targeted advertising, rather than being forced to optimize a general advertisement to appeal to as many people as possible. For instance, advertisements may be worded so that the advertisement itself informs customers that a coupon is currently available within the business location, as well as the physical location where the coupon may be obtained and where the customer can pick up the product or take part in the service being offered. This type of advertising and marketing in general ties the advertisement, the product, and the coupon together to increase impulse purchases, which account for the majority of retail purchases, particularly if the advertisement and coupon are offered at the point-of-decision. An example advertisement may read, “[s]hoppers, right now you can purchase Washington red apples for a 40% discount. A coupon is now available for a limited time only at the fruit stand in the produce section.”

### Customer Entrance Detection and Tracking System

As another exemplary embodiment, or as an alternative to random coupon dispensing, the system and method for dispensing coupons may be directly related to those specific individuals currently present within the store as determined by a customer entrance or presence detection and tracking system and based upon various customer information stored within a customer information storage and management system.

Customer entrance detection and tracking system 22 may be any system known in the art for detecting a particular customer. This may include a customer loyalty or other card that the user swipes as he/she enters a business location, one or more biometric devices, such as a fingerprint or retinal scanning device, a manual input device that the customer may activate to alert the business of their presence, a product scanning device that tracks the items purchased by a customer, or any other similar system. The purpose of customer detection and tracking system 22 is to allow a business location to detect and track the customers that enter.

Customer entrance detection and tracking system 22 is closely tied with customer information storage and management system 26. Information obtained from the customer may be stored and managed/manipulated using customer information storage and management system 26. These two systems may or may not be integrated with one another, but in a preferred embodiment they are. Embodiments may include each system operating separately, but wherein the functions of each are carried out for the purpose of detecting customers, retrieving stored data about the customers, and using the data to provide a more intelligent couponing system.

Customer information may be general (i.e., pertaining to customers as a whole or to an isolated and identifiable group of customers) or specific (i.e., pertaining to a particular customer). Customer information may be gathered using one or more common means, such as through a customer loyalty or preferred customer program, through a through unilateral solicitation by a business for information about its customers, through various surveys or questionnaires, or other known or not yet discovered means. Essentially, the present invention contemplates any type of system or method that may be used to obtain, store, and manage customer information for later use. Some of the more specific functions of customer detection and tracking system 22 include, but are not limited to, detecting and identifying a customer, monitoring the customers in the business location at all times, tracking the shopping behavior of the customers, tracking the purchase habits of the customers, and interfacing with customer information storage and management system 26 to store and manage the data. Some of the specific functions of customer information storage and management system 26 include, but are not limited to, receiving personal and other demographic information about a customer, as well as any other pertinent information, storing this information in a computer database, compiling the information into a usable format, and managing and manipulating the information as desired.

The customer entrance detection and tracking system 22 and the customer information storage and management system 26 may be utilized to improve the overall couponing functions of the intelligent in-store couponing system 18. By detecting customer presence and having available useful information about customers, various coupons may be provided based on this information. For example, if a particular customer was detected and the information retrieved for that customer indicated that he or she likes a particular kind of item because of previous purchases or some other indicia, a coupon may be triggered (e.g., either manually or automatically) that offers to the customer some type of promotion or discount or other incentive to purchase that item.

The customer entrance detection and tracking system 22 also allows the intelligent in-store couponing system to automatically load any available coupons that might be of interest to the customer based on information already obtained or learned from the customer. In one exemplary embodiment or operating arrangement, a customer would enter the business location where he/she would be detected, the customer, knowing that he/she has been detected would, if desired, access a coupon delivery system and search or scan for any available coupons that are of interest to the customer. Different coupons may be loaded into the coupon delivery system depending upon the customers currently present and detected. Moreover, coupons may be loaded for individual customers, for groups or types of customers, and/or for a population of customers as closely representative of the products or services that are to be promoted.

Still further, customer detection and tracking system 22 allows a business to identify the presence of demographically similar customers. In such cases, coupons may be generated and made available that might be of interest to the type of customers within the identified group. These examples are merely representative of some of the possible couponing methods that are possible as a result of an association with a customer entrance detection and tracking system. As one skilled in the art will recognize, there are numerous other couponing methods that are made available by the association of the intelligent in-store couponing system with a customer entrance detection and tracking system.

The customer entrance detection and tracking system 22 and the customer information storage and management system 26 may further be integrated or interfaced with the in-store media broadcasting system 14 to increase the intelligence of the couponing of a business location or business chain even more. Through the combined use of these two systems, a business may automate much of the couponing process. Of course, semi-automatic or manual couponing is still made available. By utilizing these two systems, customers may be detected. As they are detected, various media broadcasts can be loaded and played that would be most appealing to the detected customers. The content of these broadcasts and the particular arrangements could be based on already obtained and pre-determined demographic and other customer information stored in the system.

Thus, depending upon which customers are present at a given time, different in-store media broadcasts may be selected or triggered for play. In turn, those advertisements could have associated with them various related or otherwise relevant coupons that could be offered to customers in response to the broadcasted advertisement.

### Coupon Management Module

The present invention intelligent in-store couponing system further comprises a coupon management module, which is preferably a computer program comprising computer code stored on a tangible medium for directing a computer to generate, receive, cause to be stored, organize, manage, retrieve, and transfer or deliver in-store coupons. In one exemplary embodiment, the coupon management module includes, among other things, means for generating a coupon, means for receiving a coupon, means for storing a coupon, means for organizing and managing a plurality of coupons, means for retrieving a coupon, and means for transferring or delivering a coupon to a coupon delivery system. Means for generating a coupon may comprise a computer code that directs a computer to prompt the user to enter specific data or coupon parameters (e.g., time of validity for coupon, type of discount or incentive, product or service to be applied to, etc.), or it may comprise computer code that allows a user to generate a coupon from pre-existing stored data. Means for receiving a coupon comprises any type of hardware or software for receiving data for inclusion into a coupon, or a coupon itself, or for use in managing or otherwise controlling coupons. Means for storing a coupon comprises any type of memory storage device as described herein capable of storing coupons and any data related to coupons. Means for organizing and managing a plurality of coupons comprises computer code that directs a computer to organize and manage coupons based on user input, automatically, or any other known means for managing a database of data. Means for retrieving a coupon comprises computer code that directs a computer to search for a coupon based on user input or selected search criteria. Means for transferring or delivering comprises computer code that directs a computer to deliver the data for any retrieved or loaded coupon to a coupon delivery device. Essentially, the coupon management module comprises any type of computer software program that allows a user to control the couponing systems and methods existing within or to be carried out for a business location or business chain.

The coupon management module may be in communication with one or more coupon databases that contain pre-existing coupons, data relating to the coupons, or data that may be used to generate a coupon. These coupons may be generated by advertisers, store owners, and others authorized to do so. One aspect of the coupon management module may be providing a coupon search tool for customers. Thus, as a customer enters a business location he or she may access a coupon generation and delivery system having a user interface that allows the customer to search for or scan a database of pre-existing coupons for any that may be of interest to the customer. In this regard, the customer is allowed to access the one or more coupon databases managed through the coupon management module.

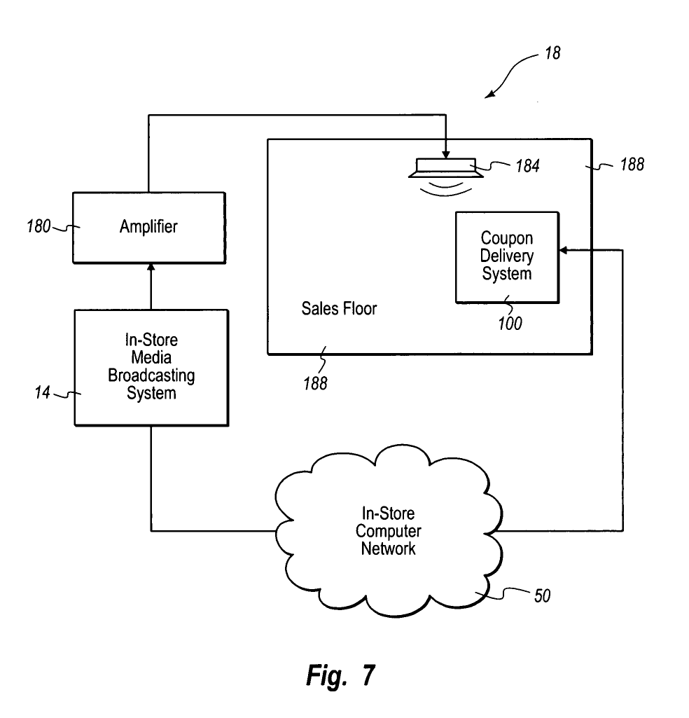

With reference to FIG. 7, shown is intelligent in-store couponing system 18 in the form of an exemplary paper couponing system existing within a retail business chain having sales floor 188. All aspects of intelligent in-store couponing system 18 are controlled by in-store media broadcasting system 14, which functions as described above, namely to broadcast media through amplifier 180 and out of speaker 184 located on the sales floor 188. In communication with in-store media broadcasting system 14 is coupon delivery system 100, which operably connects to in-store media broadcasting system 14 via in-store computer network 50. In-store computer network 50 is shown as a local area network, such as an Intranet, and is capable of connecting a plurality of coupon delivery systems 100. Coupon delivery system 100 is shown existing on sales floor 188, which means it could be in the form of a kiosk system, an aisle or POD system, a shopping cart system, POS system, or other similar system. Any coupons delivered to customers is printed out on a paper coupon via coupon delivery system 100. Once printed, the customer can physically take the coupon for later redemption, such as at the point-of-sale. As such, coupon delivery system 100 must and does comprise the necessary components to print a paper coupon, such as a computer or computer network connection for receiving a print command, a temporary memory storage device (e.g., a printing cache or print queue), paper, ink, and a printer. Couponing, including the generation, synchronization, delivery, etc. may take place in accordance with any of the couponing means, systems, methods, or operating arrangements discussed herein. In the embodiment shown, the coupons printed on coupon delivery system 100 are synchronized with the broadcast provided by in-store media broadcasting system 14 so that as a particular advertisement plays, an appropriate or corresponding coupon is delivered. In a related embodiment, coupon delivery system 100 is made generic so that all coupon information is sent to coupon delivery system 100, where the coupon is then printed on demand. Preferably, the coupons are driven from the same data source as the advertisements.

Another embodiment may comprise integration or an interface with a customer entrance detection and tracking system, or a combination of these.

The present invention also contemplates a stand-alone (e.g., a non-network system) coupon delivery system. Although a stand-alone system is simple, it is largely inflexible. A stand-alone system may, however, still be synchronized with advertisements. This would require advanced knowledge knowing when certain advertisements will play and how much the coupon is worth. As such, various coupons would have to be pre-loaded into the system.

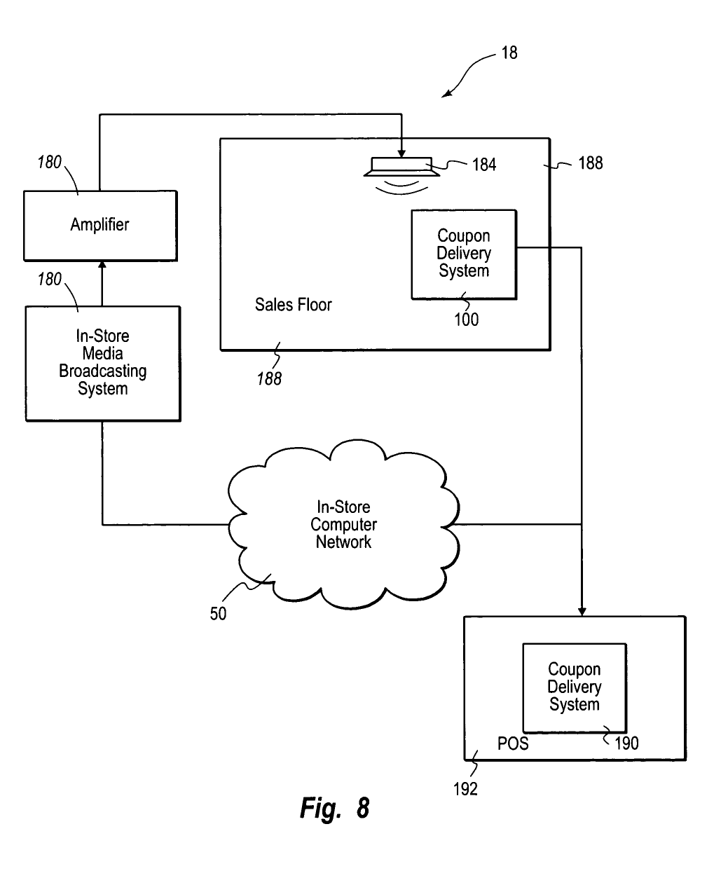

FIG. 8 illustrates a similar operating arrangement as the one illustrated in FIG. 7. However, the exemplary embodiment in FIG. 8 comprises a paper or a paperless coupon printing arrangement. Although many of the same components exist as illustrated in FIG. 7, the arrangement in FIG. 8 illustrates an additional coupon delivery system 190 shown outside or without sales floor 188. Coupon delivery system 190 represents a coupon delivery system not physically network connected to intelligent in-store couponing system or that is not physically present within the business location. Thus, coupon delivery system 190 may comprise a customer's personal electronic device, such as a cell phone, personal digital assistant (PDA), or other device through which a coupon may be delivered to the customer through customer notification means. Coupon delivery system 190 may also comprise an internet web-site that a customer may access through the Internet from any location to print, download, or search for coupons.

Coupon delivery system 100 may also comprise a paperless coupon system. The coupon delivery system may comprise a swipe card reader located on a kiosk, a shopping cart, or anywhere in the store, wherein coupon delivery system 100 would download a coupon to a customer's coupon or loyalty card (a smart card). The electronic coupon would be transferred to the smart card for later redemption at checkout. One way of redeeming the coupon would be to associate the coupon with the customer's identification in a customer information database, which is interfaced with the POS system for application of the coupon during checkout. This would require a connection to the business location's database.

Some of the advantages to paperless or electronic coupons include a reduction in maintenance of coupon delivery systems because there would be no need to replace things, such as paper or ink. Also, customers may easily carry a plurality of coupons without having to keep track of several papers. Other advantages exist as will be apparent to one skilled in the art.

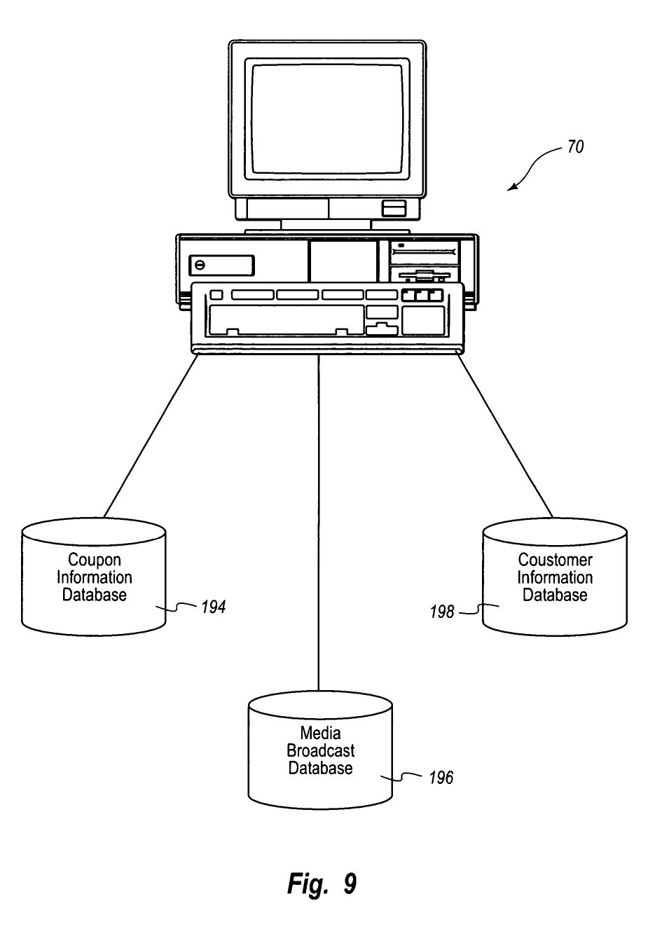

FIG. 9 illustrates a diagram of an operating computer 70 that is used to control the functions and operations of the intelligent in-store couponing system. In a preferred embodiment, intelligent in-store couponing system comprises or has integrated with it an in-store media broadcasting system and a customer information storage and management system that works in conjunction with a customer entrance detection and tracking system. Each of these systems comprises a database of stored information that operating computer may access for later use. Intelligent in-store couponing system comprises a coupon database having various coupons and coupon information stored therein. In-store media broadcasting system comprises a media broadcast database that contains media content to be used during a broadcast. Customer information storage and management system comprises a customer database containing information about the customers of a business location or business chain. Customer information may include, but is not limited to, demographic information, such as the customer's age, gender, and address, the purchases a customer has made in a previous time frame (e.g., week, month, year), the number of times the customer has visited a particular business location, impulse purchases a customer has made upon receipt of a coupon, and any other data pertaining to a customer that may be useful to a merchant.

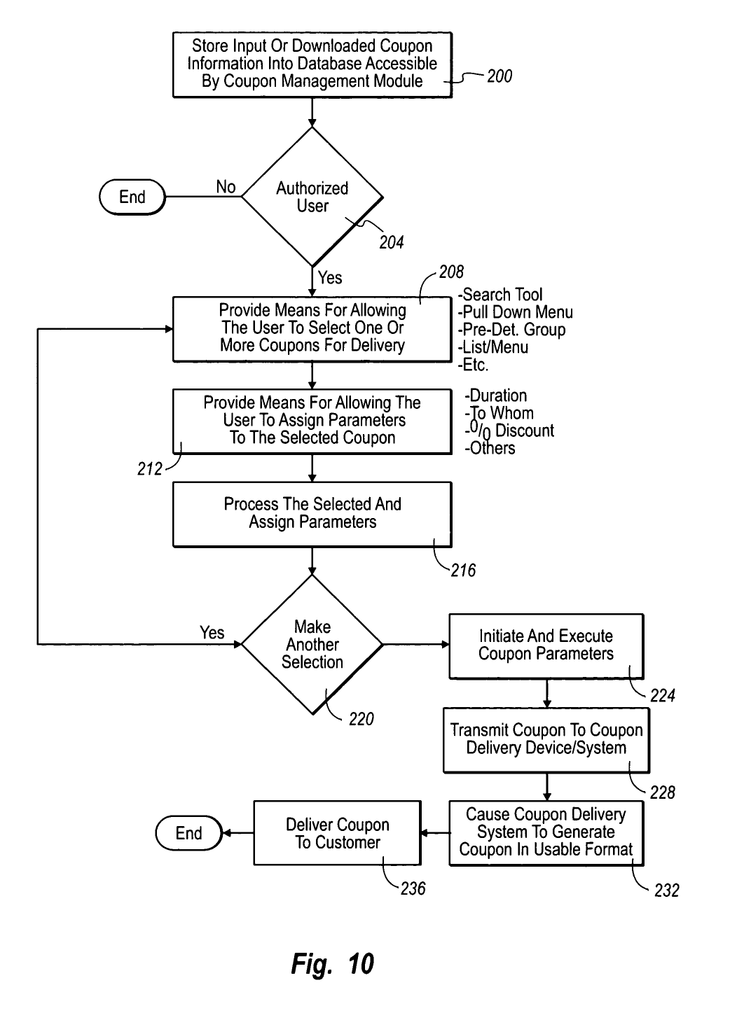

Referring now to FIG. 10, shown is a flowchart of an exemplary method for providing intelligent in-store couponing. The intelligent in-store couponing system comprises the necessary software and hardware to carry-out the following steps in this and other methods described herein. As shown in FIG. 10, the method comprises step 200, storing input or downloaded coupon information into a database accessible by a coupon management module. This step comprises any type of data input methods known in the art, such as manual user entry, downloading or file transferring existing coupon information from a server or other remote computer, transferring existing coupon information from a memory storage device, such as a floppy disk, CD/DVD-ROM, scanning, etc.; as well as any methods for providing a coupon database and storing the coupon information into the coupon database to be managed by coupon management module.

The method also includes step 204, wherein the system determines whether or not the user is authorized to access the coupon management module. This determination may be made by prompting the user for a password or other identifying indicia that the user must input, or it may be determined through an identification device, such as a biometric scanner, a fingerprint scanner, etc. Other types of identifying systems and methods known by those skilled in the art of user identification are contemplated herein. If the user is not authorized, the system remains unavailable to the user and ends the user's ability to further access the system. If the user is authorized and this is determined as such by the system, the next step, step 208, comprises providing means for allowing the user to select, or means for selecting, one or more coupons for delivery. Means for selecting comprises any type of known selection method, including, but not limited to, providing a search tool where the user can enter key words, such as the name of a product, into a search query to search the coupon database for any matches; providing a pull down menu listing the coupons available for selection; providing a listing or menu of all coupon in the database that the user may view and select; and others. Upon selecting one or more coupons for delivery, the system provides the user the ability to assign parameters to the selected coupon, step 212. Means for assigning parameters may include any known user interface that allows a user to select and assign different parameters to the coupon governing the redemption of the coupon by the customer. Parameters may include, the amount of the coupon, the percent discount of the coupon, to whom the coupon may be provided, the expiration date or validity period of the coupon, delivery instructions or rules, to what type of delivery system the coupon is to be sent, the number of coupons to be provided, and any other incentives that are to be associated with the coupon, such as buy one, get the next half off, and others.

Thus, when the system delivers the coupon to the customer, the parameters assigned to the coupon are stored in the system and then function to govern the redemption of the coupon by the customer. Once the parameters are assigned, the system processes the selected coupon and its associated parameters, step 216. The system may then prompt the user to select another coupon, step 220. If the user elects to do so, then he or she is taken back to the selection screen and is given the opportunity to select another coupon, step 208. If the user does not wish to select another coupon, the system initiates and executes the various parameters assigned to the coupon prior to delivery, step 224. Once the parameters are in place the system transmits the coupon to the delivery device or system, step 228. The system then causes the coupon delivery system to generate the coupon in a customer usable format, step 232, according to the assigned parameters. Once in a customer usable format, the coupon is then delivered to the customer for redemption, step 236. As described above, the delivery of a coupon may be in a paper or paperless (electronic) format within one of the several operating arrangements described herein.

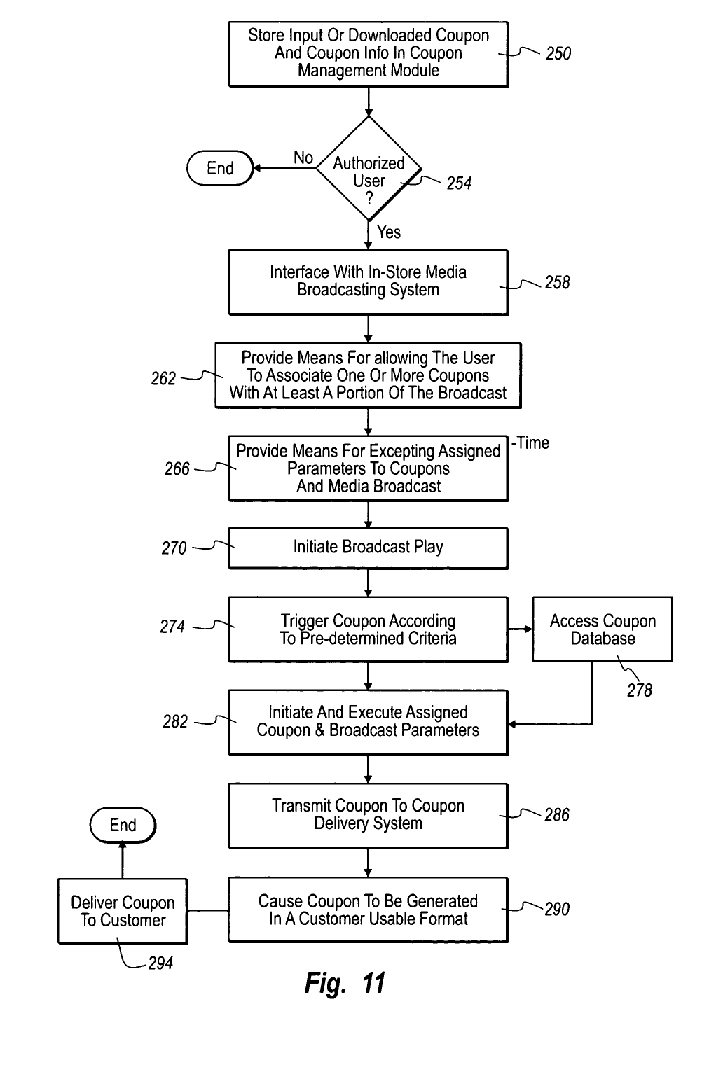

With reference to FIG. 11, shown is a flowchart of another exemplary method for providing intelligent in-store couponing, which comprises interfacing into an intelligent in-store couponing system an in-store media broadcasting system. In this embodiment, the method comprises step 200, storing input or downloaded coupon information into a database accessible by a coupon management module, and providing access to an authorized user, step 254. These steps are similar to the like steps described above in FIG. 10. The method further comprises interfacing or integrating an in-store couponing system with an in-store media broadcasting system, step 258, like the one described above. This allows the in-store couponing practices of a business location to be synchronized or otherwise tied to a media broadcast for increased advertising and sales effects. Interfacing or integrating the intelligent in-store couponing system with a media broadcast system provides advertisers and store owners/managers/employees the ability to, among other things, associate one or more coupons with a broadcast segment (e.g., advertisement, announcement, video), to automatically deliver coupons based on a broadcast segment to more effectively promote goods and services to a targeted audience, and to increase the influence of customers at the point-of-sale, as well as at the point-of-decision, thus increasing the marketing efforts of business. As such, step 262 comprises means for allowing a user to associate one or more coupons with at least a portion or segment of a broadcast, such as an advertisement. Association of a coupon may be accomplished by manually triggering a coupon in response to a played media broadcast, automatically according to a pre-arranged program schedule, or any other known means. Once coupons have been associated with a segment of a broadcast, the system provides means for accepting assigned parameters to coupons and the media broadcast, step 266. Assigning parameters to a coupon may be accomplished as described above. Assigning parameters to a media broadcast segment may be accomplished in a similar manner, and may include the time of day the segment is to be played, the frequency the segment is to be played, the days the schedule is to be played, any custom parameters that are available, and others. Upon assigning parameters, step 270 comprises initiating the playing of the broadcast at the business location. As the broadcast is being played, coupons are delivered upon being triggered by the segment to which they are associated or by any other pre-determined triggering events or parameters, step 274. As the triggering segment is played, the system accesses the coupon database, step 278, initiates and executes the assigned parameters, step 282, transmits the coupon to a designated coupon delivery system or device, step 286, causes coupon to be generated in a customer usable format, step 290, and delivers the coupon to a customer, step 294, each of these as described above.

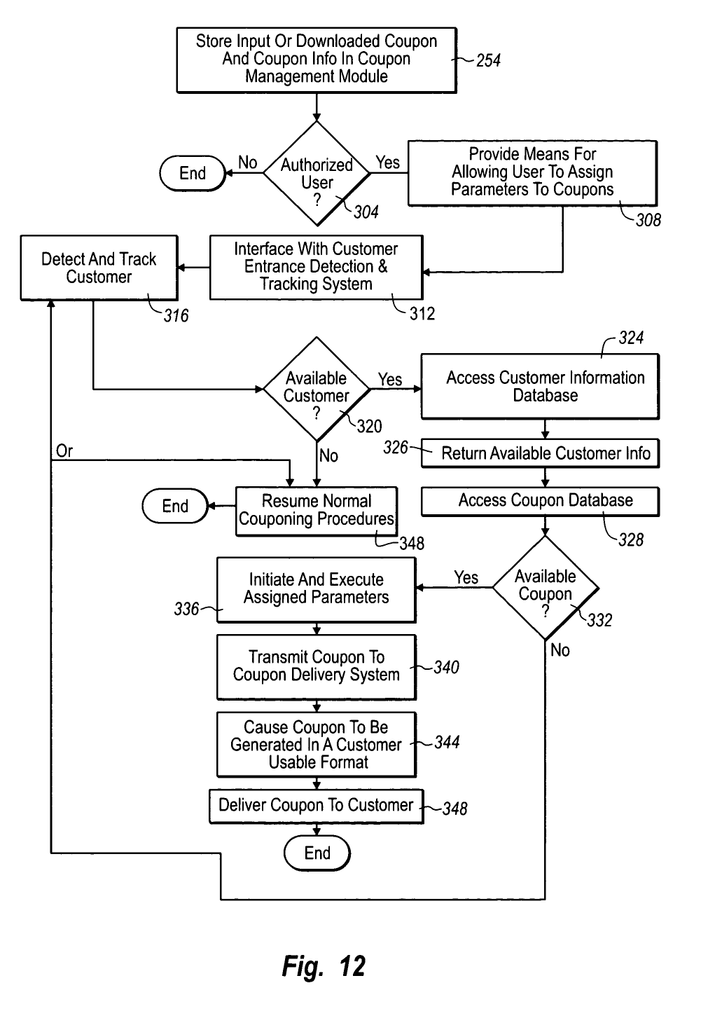

FIG. 12 illustrates a flowchart of another exemplary method for providing intelligent in-store couponing, which comprises interfacing into an intelligent in-store couponing system both an in-store media broadcasting system and a customer entrance detection and tracking system, as well as a customer information storage and management system, if separate from the customer entrance detection and tracking system. In this embodiment, the method comprises step 300 comprising storing input or downloaded coupons and coupon information into a coupon database managed by a coupon management module. This is as described above. The method further comprises identifying a user as an authorized user, step 304, and providing means for allowing a user to assign parameters to coupons, step 308. Steps 304 and 308 are also discussed above. Step 312 comprises interfacing or integrating the intelligent in-store couponing system with a customer entrance detection and tracking system, step 312, capable of detecting the presence of particular customers and tracking their in-store behavior, step 316. As all customers may not have information currently obtained, the system checks to see if the customer is available in the customer database, step 312. If not, non-customer related couponing procedures and methods may be resumed, step 348, which may include manual triggering of coupons as various broadcast segments are played, or defaulting to a regular scheduled broadcast schedule with coupons associated with different segments of the broadcast. If customer information is available, the system can access the customer information database, step 324, and return the available customer information, step 326, for matching with one or more coupons. Based on the returned customer information, the system then accesses the coupon database, step 328, to determine, step 332, if there is a coupon available that would be of interest to the customer based on the returned customer information. If no coupons are created, one or more coupons may be created. Or, the system may return to or resume non-customer related couponing procedures. Or, the system may again initiate step 316 to search for another customer. If there are coupons available, the system initiates and executes the assigned parameters, step 336, transmits the coupon to a designated coupon delivery system or device, step 340, causes coupon to be generated in a customer usable format, step 344, and delivers the coupon to a customer, step 348, each of these as described above.

It should be noted that the method illustrated in FIG. 12 may also comprise the additional step of interfacing or integrating both the couponing and the customer detection systems with an in-store media broadcasting system, wherein customers may be detected and both the broadcast content and the delivered coupons would be based upon the customers detected at the business location.

Each of these above-described systems and methods of the present invention intelligent in-store couponing system provide significant advantages to both business owners and advertisers over prior related couponing systems and methods. First, the intelligent in-store couponing system allows businesses to immediately control and alter the purchasing conditions of the products or services currently being offered. Second, in-store personnel are able to effectively influence the decision-making and purchasing habits of the customer while they are actually within the business location. More particularly, in-store personnel are able to influence and entice customers at the very point-of-decision and point-of-sale. Third, advertisements are made more effective because customers may be immediately provided a coupon for the very products being advertised. Fourth, advertisers may change the way they advertise. For instance, they may be able to produce advertisements that are more customer-specific and they may be able to get away from the generalizations that are often wide-spread in advertising. Fifth, couponing may be in direct response to advertisements, announcements, etc., thus further stimulating a customer to purchase a product or service. One skilled in the art will recognize other advantages not specifically recited herein, and these are intended to be within the scope of the present invention.

### Methods for In-Store Couponing (Business Methods)

The present invention features several methods of using the intelligent in-store marketing systems and methods described above to conduct business within a store location. Rather, the present invention features several methods of using the intelligent in-store marketing system to carry out various intelligent or smart functions within a store location, including, but not limited to intelligent advertising, intelligent selling and promoting of goods and services, intelligent discounting and promoting, intelligent store-related customer messaging or contact or interaction, and intelligent return-on-investment analysis and reporting based on any of these.

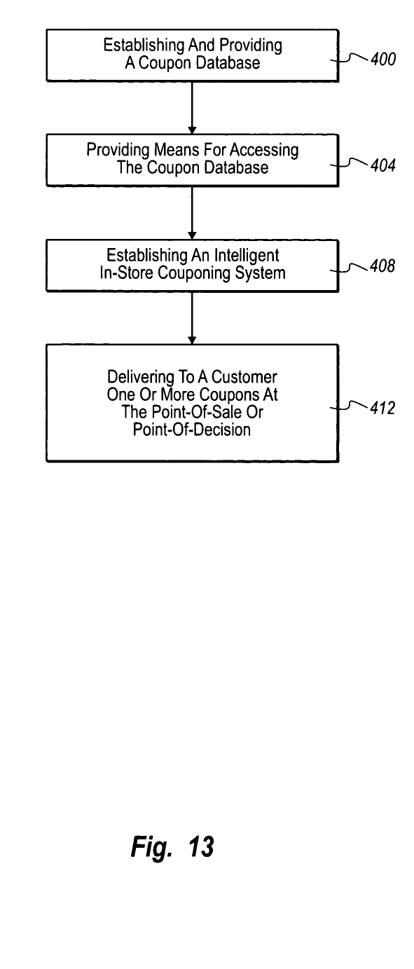

With reference to FIG. 13, shown is one exemplary method for couponing comprising step 400, establishing and providing a coupon database comprising stored or input or downloaded coupons and coupon information; step 404, providing means for accessing the coupon database; step, 408, establishing an intelligent in-store couponing system; and step 412, delivering to a customer one or more coupons at the point-of-sale or point-of-decision. The intelligent in-store couponing system may be any system described above, or any obvious variant thereof. In a preferred embodiment, the intelligent in-store couponing system comprises an in-store media broadcasting system integrated with the couponing system. In another preferred embodiment, the intelligent in-store couponing system comprises a customer entrance detection and tracking system and a customer information storage and management system. In still another preferred embodiment, the intelligent in-store couponing system comprises each of these stand-alone systems. Means for accessing the coupon database comprises a coupon management module or other sufficient computer program capable of searching the coupon database and retrieving designated or selected coupons. The step of delivering comprises delivering one or more coupons to a customer using a coupon delivery system as described above.

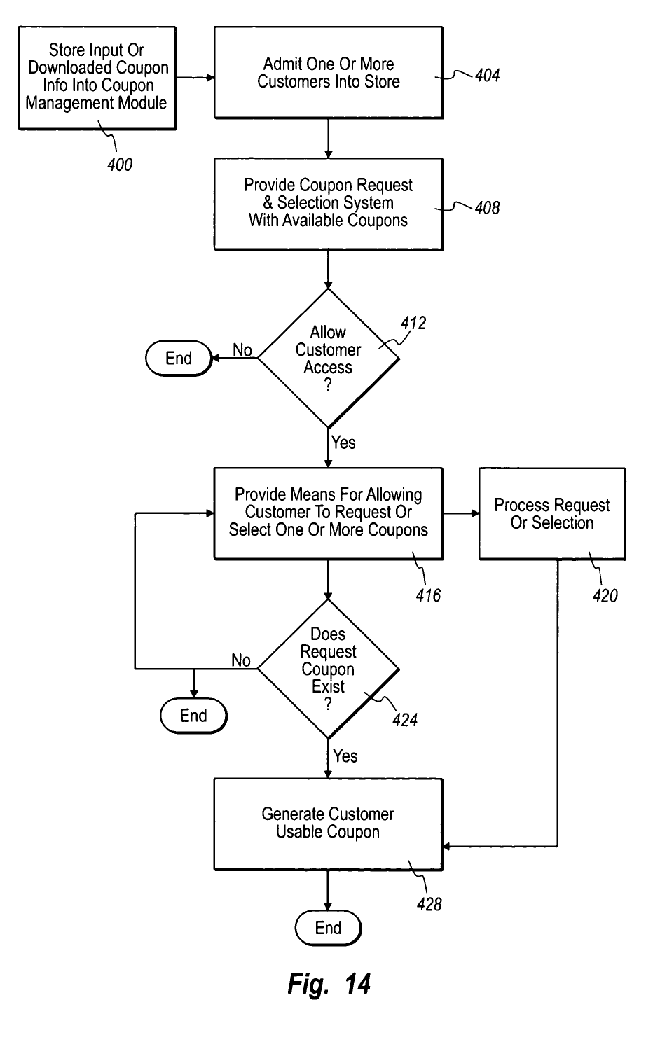

Reference is next made to FIG. 14, which illustrates one embodiment of a couponing system which incorporates the ability to confirm that the requested coupon or coupons exist. This is accomplished by providing means for allowing a customer to request or select one or more coupons 416. The requests are analyzed to determine if the requested coupon exists 424. If the coupon does exist, the request is allowed to process 420 and a coupon is generated for the customer.

While illustrative embodiments of the invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive where it is intended to mean “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

1. A method for providing intelligent in-store couponing, said method comprising:
providing a coupon database comprising at least one of stored, input, and downloaded coupon information;
providing a means for accessing the coupon database and for generating coupons with the coupon information;
establishing an intelligent in-store couponing system; and
delivering to a customer one or more coupons at at least one of a point-of-sale and a point-of-decision.

2. The method of claim 1, further comprising interfacing said intelligent in-store couponing system with an in-store media broadcast system.

3. The method of claim 2, wherein the in-store media broadcast system further includes a computer network configured to interconnect a plurality of clients and a variable media output system.

4. The method of claim 2, wherein said in-store media broadcast system is selected from the group consisting of a computer network-based media broadcast system, a satellite-based media broadcast system, and an internally isolated media broadcast system.

5. The method of claim 1, further comprising interfacing said intelligent in-store couponing system with a customer entrance detection and tracking system.

6. The method of claim 5, wherein the customer entrance detection and tracking system further includes at least one of a customer loyalty card system, a biometric data system, a manual purchase information system, and a product scanning device.

7. The method of claim 5, wherein the customer entrance detection and tracking system further includes at least one of detecting and identifying a customer, monitoring the customers in the business location at all times, tracking the shopping behavior of the customers, and tracking the purchase habits of the customers.

8. The method of claim 1, further comprising interfacing said intelligent in-store couponing system with a customer information and management system.

9. The method of claim 8, wherein the customer information and management system further includes the ability to store individual customer information including at least one of identity, gender, common items purchased, money spent, common shopping time, and age.

10. The method of claim 1, wherein said intelligent in-store couponing system further comprises a system selected from the group consisting of an in-store media broadcast system, a customer entrance detection and tracking system, a customer information and management system, a return on investment system, and a trigger-based broadcasting system.

11. The method of claim 1, wherein said coupon is a paperless coupon.

12. The method of claim 1, wherein said coupon is a paper coupon.

13. A system for providing intelligent in-store couponing, said system comprising:
a coupon database configured to store coupon information;
a coupon management module for managing the coupon information, for generating coupons based on the coupon information, and for accessing said coupon database; and
at least one coupon delivery system capable of delivering the generated coupons to a customer at at least one of a point-of-sale and a point-of-decision.

14. The system of claim 13, further comprising an in-store media broadcasting system interfaced with the coupon management module and the at least one coupon delivery system.

15. The system of claim 14, wherein the in-store media broadcasting system further includes a computer network configured to interconnect a plurality of clients and a variable media output system.

16. The system of claim 13, further comprising a customer entrance detection and tracking system interfaced with the coupon management module.

17. The system of claim 16, wherein the customer entrance detection and tracking system further includes at least one of a customer loyalty card system, a biometric data system, a manual purchase information system, and a product scanning device.

18. The system of claim 16, wherein the customer entrance detection and tracking system further includes at least one of detecting and identifying a customer, monitoring the customers in the business location at all times, tracking the shopping behavior of the customers, and tracking the purchase habits of the customers.

19. The system of claim 13, further comprising a customer information and management system interfaced with the coupon management module.

20. The system of claim 19, wherein the customer information and management system further includes the ability to store individual customer information including at least one of identity, gender, common items purchased, money spent, common shopping time, and age.

21. The system of claim 13, wherein the generated coupons are paper based.

22. The system of claim 13, wherein the generated coupons are non-paper based.

23. A system for providing intelligent in-store couponing, said system comprising:
a coupon database configured to store coupon information;
a coupon management module for managing the coupon information, for generating coupons based on the coupon information, and for accessing said coupon database;
at least one coupon delivery system capable of delivering the generated coupons to a customer at at least one of a point-of-sale and a point-of-decision;
an in-store media broadcasting system interfaced with the coupon management module and the at least one coupon delivery system;
a customer entrance detection and tracking system interfaced with the coupon management module; and
a customer information and management system interfaced with the coupon management module.
